(19) United States
(12) Patent Application Publication
(10) Pub. No.: US 2009/0186171 A1
(43) Pub. Date: Jul. 23, 2009

(54) POLARIZATION PLATE MANUFACTURING METHOD AND DISPLAY APPARATUS

(75) Inventors: Keiichi Kagami, Miyagi (JP); Kazuhide Horikawa, Miyagi (JP); Masashi Enomoto, Tokyo (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/353,583

(22) Filed: Jan. 14, 2009

(30) Foreign Application Priority Data
Jan. 17, 2008 (JP) 2008-007594

(51) Int. Cl. G02F 1/1335; B05D 5/06; G02B 1/08

(52) U.S. Cl. 428/1.31; 427/163.1

(57) ABSTRACT

Disclosed is a manufacturing method of a polarization plate. The manufacturing method includes forming a coating layer on a polarization element by coating a coating liquid obtained by dissolving polysilazane and an organic resin into a solvent, and forming an organic-inorganic hybrid layer by subjecting the coating layer to reaction curing.

### CROSS REFERENCES TO RELATED APPLICATIONS

The present invention contains subject matter related to Japanese Patent Application JP 2008-007594 filed in the Japanese Patent Office on Jan. 17, 2008, the entire contents of which being incorporated herein by reference.

### BACKGROUND OF THE INVENTION

1. Field of the Invention

The present invention relates to a manufacturing method of a polarization plate used for a display apparatus and a display apparatus including a polarization plate manufactured by the manufacturing method.

2. Description of the Related Art

A liquid crystal display apparatus as a display apparatus has a structure in which a pair of polarization plates is disposed so as to sandwich a liquid crystal panel. A polarization plate has a polarization characteristic of causing only certain polarized light out of light incident thereon to transmit therethrough and exit the same. A polarization plate includes a polarization film obtained by subjecting a uniaxially extended polyvinyl alcohol film to iodine staining, and a protection layer formed of TAC (triacetyl cellulose) disposed on both surfaces of the polarization film to protect the polarization film, for example. Further, another polarization plate in which an Si-oxide thin film layer is formed on a polarization film has been proposed (see, for example, Japanese Patent Application Laid-open No. Hei 8-262226, paragraph [0005]). There has further been proposed another polarization plate in which a polarization film is provided with an organic-inorganic hybrid layer as a protection layer that is formed by a sol-gel method using a hydrolyzed solution of alkoxysilane (see, for example, Japanese Patent Application Laid-open No. 2006-137821, paragraph [0147]).

### SUMMARY OF THE INVENTION

However, the protection layer formed of TAC has an insufficient water barrier property. For this reason, there is a problem in that a polarization degree of the polarization film deteriorates due to water intrusion from outside, or uniform polarization characteristics on a film surface cannot be obtained due to a distortion caused by deformation of the polarization film, which affects display characteristics of a liquid crystal display apparatus. In addition, the protection layer that is formed by the Si-oxide thin film layer has poor flexibility, so a crack may occur in the Si-oxide thin film layer by being stressed. When the crack occurs, there arise such problems that water intrudes from a cracked position and the polarization characteristics of the polarization plate deteriorate, thus affecting the display characteristics of the liquid crystal display apparatus. Further, in a case where the organic-inorganic hybrid layer is formed by the sol-gel method using the hydrolyzed solution of alkoxysilane, water contained in the hydrolyzed solution dissolves and swells a polarization element whose base material film is a polyvinyl alcohol film, which may cause deterioration of the polarization characteristics of the polarization element.

In view of the above-mentioned circumstances, it is desirable to provide a manufacturing method of a polarization plate in which the crack is prevented to enhance durability with the water barrier property being maintained, and a display apparatus including a polarization plate manufactured by the manufacturing method.

According to an embodiment of the present invention, there is provided a manufacturing method of a polarization plate, including: forming a coating layer on a polarization element by coating a coating liquid obtained by dissolving polysilazane and an organic resin into a solvent; and forming an organic-inorganic hybrid layer by subjecting the coating layer to reaction curing.

In the embodiment, the organic-inorganic hybrid layer is formed using polysilazane. Therefore, the organic-inorganic hybrid layer can be formed on the polarization element without impairing the polarization characteristics of the polarization element. In other words, because polysilazane reacts with water or a hydroxyl group, a solvent that does not react with polysilazane is selected, and the solvent does not intrude into the polarization element to be a coating target and does not affect the polarization characteristics of the polarization element. For example, as a method of forming the organic-inorganic hybrid layer, a sol-gel method using a hydrolyzed solution of alkoxysilane may be considered, but this method involves a process using a solution containing water, which is undesirable because water dissolves and swells the polarization element. In contrast, for forming the organic-inorganic hybrid layer according to the embodiment, a solvent that does not contain water is used, and therefore the polarization element is not intruded. Further, the organic-inorganic hybrid layer formed on the polarization element can obtain flexibility by containing an organic resin component, which can prevent a crack occurrence and deterioration of the characteristics of the polarization element due to water intrusion from the crack. In addition, the organic-inorganic hybrid layer can obtain a water barrier property by containing an inorganic component, which can prevent deterioration of the characteristics of the polarization element due to water intrusion.

Further, the organic resin is an acrylic resin.

In this way, the acrylic resin can be used as the organic resin that is compatible with polysilazane and has transparency and a water barrier property.

Further, components of the polysilazane and the organic resin in the coating liquid are dissolved in the solvent at a weight ratio of 1:9 to 3:2.

In this way, by setting the weight ratio of the polysilazane component and the organic resin component in the coating liquid to 1:9 to 3:2, the organic-inorganic hybrid layer in which a crack is prevented and which has a water barrier property can be obtained. When the ratio of the polysilazane component and the organic resin component is smaller than 1/9, a sufficient water barrier property cannot be obtained, while when it is larger than 3/2, sufficient flexibility cannot be obtained, with the result that a crack easily occurs.

Further, the polarization element has a base material film made of polyvinyl alcohol resin.

In a case where the polyvinyl alcohol resin is used as the base material film of the polarization element, when polysilazane is used for forming the organic-inorganic hybrid layer, the polarization element is not intruded because the coating liquid does not contain water.

Further, the reaction curing is performed through a heating treatment and a humidity treatment in the stated order.

In this way, by performing the heating treatment, the organic solvent can be completely removed, while by performing the humidity treatment, the polysilazane component in the coating layer can be converted into silicon oxide.

Further, the humidity treatment is performed under a condition where a temperature is 40° C. or more and 80° C. or less and a humidity is 60% or more and 90% or less.

As described above, it is desirable to perform the humidity treatment under the temperature condition of 40° C. or more and 80° C. or less. If the temperature is lower than 40° C., the reaction of the polysilazane component is not facilitated, and an unreacted component resides, with the result that the characteristics as the barrier layer becomes insufficient. If the temperature is higher than 80° C., the coating layer is subjected to the reaction curing, and water intrudes into the polarization film itself before the characteristics as the barrier layer are expressed, with the result that swelling or deformation of the film may occur. Further, it is desirable to perform the humidity treatment under the humidity condition of 60% or more and 90% or less. If the humidity is lower than 60%, the reaction of the polysilazane component is not facilitated, and an unreacted component resides, with the result that the characteristics as the barrier layer becomes insufficient.

If the humidity is higher than 90%, the coating layer is subjected to reaction curing, and water intrudes into the polarization film itself before the characteristics as the barrier layer are expressed, with the result that swelling or deformation of the film may occur.

Further, the heating treatment is performed under a temperature condition of 60° C. or more and 100° C. or less.

In this way, it is desirable to perform the heating treatment under the temperature condition of 60° C. or more and 100° C. or less. If the temperature is lower than 60° C., the organic solvent cannot be sufficiently removed. If the temperature is higher than 100° C., decolorization or thermal deformation of the film may occur when the film that has been subjected to iodine staining is used as the polarization element.

According to another embodiment of the present invention, there is provided a display apparatus including: a display cell; and a pair of polarization plates each of which includes a polarization element including a first surface and a second surface opposed to each other and an organic-inorganic hybrid layer provided on the first surface and formed by coating a solution obtained by dissolving polysilazane and an organic resin into a solvent, and are disposed so that the second surface is disposed on a side of the display cell and the display cell is sandwiched thereby.

Because the display apparatus according to the embodiment includes the polarization plate on which the organic-inorganic hybrid layer is formed, water is prevented from intruding from outside by the organic-inorganic hybrid layer. Thus, the deterioration of the polarization characteristics of the polarization plate due to water intrusion can be prevented, and therefore the display apparatus having stable display characteristics can be obtained.

As described above, according to the embodiments of the present invention, the polarization plate in which the organic-inorganic hybrid layer is formed on the polarization element can be obtained without impairing the polarization characteristics of the polarization element. Further, because the organic-inorganic hybrid layer has flexibility and a water barrier property, the crack occurrence in the organic-inorganic hybrid layer can be prevented, and the deterioration of the polarization characteristics of the polarization plate due to water intrusion into the polarization element can be prevented.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a partially enlarged cross-sectional diagram showing a polarization plate according to an embodiment of the present invention;

FIG. 2 is a partially enlarged cross-sectional diagram showing another polarization plate according to an embodiment of the present invention;

FIG. 3 is a partially enlarged cross-sectional diagram showing still another polarization plate according to an embodiment of the present invention;

FIG. 4 is a partially enlarged cross-sectional diagram showing still another polarization plate according to an embodiment of the present invention;

FIG. 5 is a schematic cross-sectional diagram showing a liquid crystal display apparatus according to an embodiment of the present invention; and

FIG. 6 is a flowchart showing a manufacturing method of the polarization plate according to the embodiment of the present invention.

### DESCRIPTION OF PREFERRED EMBODIMENTS

Hereinafter, embodiments of the present invention will be described with reference to the drawings.

(Polarization Plate)

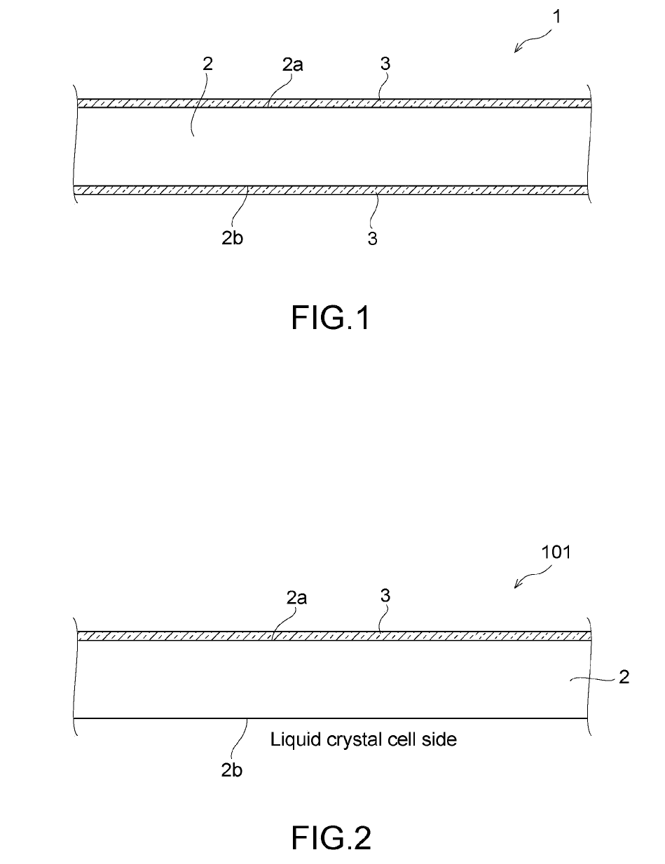

A polarization plate according to an embodiment of the present invention will be described with reference to FIG. 1.

FIG. 1 is a partially enlarged cross-sectional diagram showing a polarization plate.

A polarization plate 1 is, for example, an optical film whose planer shape is a rectangle and which has a polarization function. As shown in FIG. 1, the polarization plate 1 includes a polarization film 2 as a polarization element having a first surface 2a and a second surface 2b, and a protection layer 3 that is formed of an organic-inorganic hybrid layer and provided on the first surface 2a and the second surface 2b of the polarization film 2.

For the polarization film 2, a known film can be used. In this embodiment, a film which is subjected to iodine adsorption orientation and whose base material film is a polyvinyl alcohol resin film is used for the polarization film 2. Examples of the polyvinyl alcohol resin film include a polyvinyl alcohol film, a polyvinyl formal film, a polyvinyl acetal film, a poly(ethylene-vinyl acetate) copolymer film, a partially saponified film thereof, a completely saponified film thereof, and a polyvinyl alcohol film partially containing polyene.

The protection layer 3 is formed of an optically transparent organic-inorganic hybrid layer. The optically transparent organic-inorganic hybrid layer is obtained by bonding an acrylic resin as an organic resin that is film-formed by a manufacturing method described later and an Si oxide on a molecular scale. By using the organic-inorganic hybrid layer as the protection layer 3, the water intrusion into the polarization film 2 is prevented, and the protection layer 3 having flexibility can be obtained. Because the protection layer 3 prevents the water intrusion into the polarization film 2, deteriorations of the polarization characteristics such as reduction of the polarization degree of the polarization plate 1 due to the water intrusion into the polarization film 2 and non-uniformity of the polarization characteristics due to deformation of the polarization film caused by water swelling can be prevented. In addition, the protection layer 3 has flexibility and therefore hardly cracks even when the polarization plate 1 receives an external pressure and bends. Therefore, the water intrusion into the polarization film from a crack can be prevented, and thus the polarization plate whose polarization characteristics are prevented from deteriorating due to the water intrusion and which is excellent in durability can be obtained.

(Manufacturing Method of Polarization Plate)

A manufacturing method of the polarization plate 1 described above will be described with reference to FIG. 6.

FIG. 6 is a flowchart showing a manufacturing method of the polarization plate.

First, the polarization film 2 made of a polyvinyl alcohol resin subjected to iodine adsorption orientation was prepared with the polarization film 2 being formed into a sheet having a predetermined size. The polarization film 2 includes the first surface 2a and the second surface 2b opposed to each other. It is to be noted that the polarization film 2 can be formed by a known method such as a method in which a polyvinyl alcohol resin film that is not yet extended is immersed into an iodine and potassium iodide solution and then uniaxially extended, and a method in which a uniaxially extended polyvinyl alcohol resin film is immersed into the iodine and potassium iodide solution.

Further, as a coating liquid to be formed into the organic-inorganic hybrid layer, a mixture of a polysilazane solution and an organic resin solution was prepared. As the polysilazane solution, a perhydrogenized polysilazane solution (NP110-20) manufactured by AZ Electronic Materials was used. The solution was obtained by dissolving perhydrogenized polysilazane represented by the following formula I as polysilazane into a xylene solvent by 20 wt %.

—(SiH₂NH)ₙ— I

(where n represents an integer)
Further, as the organic resin solution, a solvent obtained by dissolving the acrylic resin (methyl methacrylate polymer, manufactured by MITSUBISHI RAYON CO., LTD., BR-80) into a toluene solvent by 10 wt % was used.

Next, the above-mentioned coating liquid obtained by mixing the polysilazane solution and the organic resin solution was coated on one surface, the first surface 2a in this case, of the polarization film 2 using a spin coater (coating process). Specifically, the coating liquid was dropped onto the polarization film 2 and the polarization film 2 was rotated at 1,000 rpm for 30 minutes. As a result, a coating layer whose thickness is about 0.6 to 1.2 μm (in this embodiment, 1 μm) was obtained. The solvent contained in the coating layer is almost entirely evaporated during rotation with the spin coater. Therefore, a dried coating layer can be obtained.

In this embodiment, the spin coater was used for coating the coating liquid, but the method is not limited thereto.

A spray coating method, a gravure coating method, a doctor blade method, a dip coating method, or the like may instead be used.

Next, the coating liquid obtained by mixing the above-mentioned polysilazane solution and the organic resin solution was coated onto the second surface 2b as the other surface of the polarization film 2, by the same method used with respect to the first surface 2a. As a result, a coating layer was obtained like the first surface 2a.

Subsequently, the coating layer formed on the polarization film 2 was subjected to a heating treatment at 80° C. for 1 hour (heating treatment process), and then subjected to a humidity treatment for 1 hour in an environment in which the temperature is 60° C. and the humidity is 60% (humidity treatment process), and the coating layer was subjected to reaction curing. The reaction curing process causes a reaction in which a polysilazane component in the coating layer is converted into a silicon oxide. At this time, an organic resin component is formed as the organic-inorganic hybrid layer obtained by complexing an organic resin component and an inorganic component derived from polysilazane on an extremely minute scale equal to or lower than several tens of nanometers, in order to be solidified from a state of being a solution that is compatible with the polysilazane component. This microstructure is more minute than a wavelength of visible light, and thus does not affect permeability as a layer. By the curing, the protection layer 3 formed of the organic-inorganic hybrid layer was obtained. A thickness of the protection layer 3 is 0.3 μm or more and 10 μm or less (1 μm in this embodiment). It is to be noted that if the layer thickness is less than 0.3 μm, an effect of preventing vapor transmission becomes poor and sufficient humidity protection function cannot be obtained. On the other hand, if the layer thickness is more than 10 μm, water infiltration necessary for the reaction becomes difficult, which makes the reaction curing process difficult and impairs flexibility of the coating layer, causing a crack to easily occur.

In the reaction curing, by performing the heating treatment, the organic solvent can be completely removed, while by performing the humidity treatment, the polysilazane component in the coating layer can be converted into silicon oxide.

Further, in this embodiment, the heating treatment was performed at 80° C. for 1 hour. It is desirable to perform the heating treatment at 60° C. or more and 100° C. or less. If the temperature is lower than 60° C., the organic solvent cannot be sufficiently removed. On the other hand, if the temperature is higher than 100° C., the polarization film that has been subjected to iodine staining may be decolorized or the film may be thermally deformed. A treatment time may be appropriately adjusted in accordance with the treatment temperature so as to completely remove the organic solvent. Further, it is desirable that the humidity treatment is performed at 40° C. or more and 80° C. or less. If the temperature is lower than 40° C., the reaction of the polysilazane component is not facilitated and unreacted component remains, so the characteristics as a barrier layer become insufficient. On the other hand, if the temperature is higher than 80° C., the coating layer is subjected to the reaction curing and water intrusion into the polarization film itself occurs before the characteristics as the barrier layer are expressed, and thus the swelling or deformation of the film may occur. It is desirable to perform the humidity treatment under a humidity condition of 60% or more and 90% or less. If the humidity is lower than 60%, the reaction of the polysilazane component is not facilitated and unreacted component remains, so the characteristics as the barrier layer become insufficient.

On the other hand, if the humidity is higher than 90%, the coating layer is subjected to reaction curing and water intrusion into the polarization film itself occurs before the characteristics as the barrier layer are expressed, and thus the swelling or the deformation of the film may occur.

A mixture ratio (weight ratio) of the polysilazane solution and the organic resin solution in the coating liquid described above was changed as shown in Table 1, and 10 specimens were produced.

### (Table 1)

Examples 1 to 5 in Table 1 are polarization plates on which organic-inorganic hybrid layers were formed by using coating liquids whose weight ratios of the polysilazane solutions and the organic resin solutions contained in the coating liquids were 3:4, 1:2, 1:3, 1:8, and 1:18, respectively, that is, weight ratios of polysilazane components and acrylic resin components as organic resin components contained in the coating liquids were 3:2, 1:1, 2:3, 1:4, and 1:9. In Table 1, Comparative example 1 is a polarization plate with no protection layer, and Comparative example 2 is a polarization plate on which a silicon oxide layer was formed as the protection layer by using a coating liquid containing the polysilazane solution. Comparative example 3 is a polarization plate on which an organic-inorganic hybrid layer was formed by using a coating liquid whose weight ratio of a polysilazane solution and an organic resin solution contained therein was 7:6, that is, a weight ratio of a polysilazane component and an acrylic resin component contained therein was 7:3. Comparative example 4 is a polarization plate on which an acrylic resin layer was formed as the protection layer by using a coating liquid containing an acrylic resin solution. Comparative example 5 is a polarization plate manufactured by a method of related art in which triacetyl cellulose (TAC) was used as the protection layer. In this case, a TAC film having a thickness of 80 μm was stuck on each side of the polarization film. It is to be noted that, on the polarization plates as the specimens except for the polarization plate of Comparative example 1, the protection layers were formed on both sides thereof. Herein, a reason why a term “component” is used like the polysilazane component and the organic resin component is that a state where polysilazane and an organic resin are dissolved in a solvent does not show a form of polysilazane and the organic resin. Therefore, the polysilazane component indicates a structural portion whose base is polysilazane dissolved in the solvent, while the organic resin component indicates a structural portion whose base is an organic resin dissolved in the solvent.

Table 2 shows evaluation results of the 10 specimens described above.

### (Table 2)

The obtained 10 polarization plates as the specimens were subjected to an endurance test in which they were held for 200 hours in a high-temperature, high-humidity environment where the temperature was 60° C. and the humidity was 90%. Then, evaluations were made on the polarization plates by measurement of change in polarization characteristics and external observation before and after the test. Further, hardness of the protection layers of the polarization plates as the specimens was measured. In Comparative example 1 in which the protection layer was not formed, the hardness of the polarization film was measured.

As shown in Table 2, any of the polarization plates showed a polarization degree of 99.98% before the test. But after the test, the polarization degrees of the polarization plates of Comparative examples 1 to 5 decreased. In particular, in Comparative example 1 with no protection layer, the polarization degree of the polarization plate markedly decreased.

In Comparative example 1, size deformation of the polarization film occurred due to water swelling, with the result that the polarization plate became difficult to be used as such. In Comparative example 2, the change in the polarization degree after the test was suppressed as compared to Comparative example 1, and the deformation of the polarization film was also suppressed. However, a crack occurred in the protection layer, and water intruded from the crack portion, resulting in decolorization around the crack. In Comparative example 3, the change in the polarization degree after the test was suppressed as compared to Comparative example 1, and the deformation of the polarization film was also suppressed. However, a crack occurred in the protection layer although it was smaller than that in Comparative example 2. This is because, even when the organic-inorganic hybrid layer is used as the protection layer, if the protection layer has a high proportion of the inorganic components, film characteristics become similar to that of an inorganic film, and therefore sufficient flexibility cannot be obtained. In Comparative example 4, the change in the polarization degree before and after the test was observed although it was suppressed as compared to Comparative example 1, and no crack occurred in the protection layer, but the deformation of the polarization film occurred. Accordingly, the polarization plate became difficult to be used as such. In Comparative example 5, the change in the polarization degree before and after the test was observed although it was also suppressed as compared to Comparative example 1.

Any crack and external change was not observed.

In contrast to those comparative examples, regarding the polarization plates of Examples 1 to 5, no change in polarization degree before and after the test was observed, no crack occurred in the protection layers, and no external change such as deformation was observed. That is, by imparting the organic resin component to the protection layer, flexibility can be obtained, and by imparting the inorganic component to the protection layer, a water barrier property can be obtained. Further, by setting the weight ratio of the polysilazane component and the acrylic resin component in the coating liquid that forms the protection layer to 3:2 to 1:9, the polarization plate 1 including the protection layer 3 formed of the organic-inorganic hybrid layer which has appropriate flexibility and water barrier property and whose durability is enhanced can be obtained.

In addition, the protection layer of the polarization plate of each of Examples 1 to 5 has pencil hardness of 3H to 4H, and hardly gets a crack. Therefore, there is no need to additionally provide a hard coat layer for preventing a crack on the surface, and thus a thinner layer can be obtained than in a case where the hard coat layer is provided.

To the above-mentioned coating liquid, a catalytic component, e.g., a metal fine particle such as Au (gold), Ag (silver), Pd (palladium), and Ni (nickel), and an amine compound such as triethylamine, tripentylamine, tributylamine, trihexylamine, triheptylamine, and trioctylamine may be added in order to enhance reactivity in the coating layer curing process. As a result, the reaction temperature can be lowered, and the coating layer can be cured without thermal deformation of the polarization film and deterioration of the polarization characteristics.

Further, polysilazane reacts with water or hydroxyl, and therefore is dissolved in a solvent such as benzene, toluene, xylene, ether, THF, methylene chloride, and carbon tetrachloride, to obtain a polysilazane solution. In contrast, the polarization film 2 as a coating target whose base material film is a polyvinyl alcohol resin is an insoluble or poorly soluble material with respect to the above-mentioned solvent. Accordingly, coating of the coating liquid does not cause water intrusion into the polarization film 2. For example, as a formation method of the organic-inorganic hybrid layer, a sol-gel method using a hydrolyzed solution of alkoxysilane can be used. But a solution used in a process of the method contains water, which may undesirably cause the polarization film 2 to be dissolved and swollen. Thus, the organic-inorganic hybrid layer is formed on the polarization film 2 whose base material film is the polyvinyl alcohol resin using polysilazane as in the present invention, which prevents water intrusion into the polarization film 2, with the result that the polarization plate 1 having excellent polarization characteristics can be obtained.

In this embodiment, a solvent capable of dissolving both of polysilazane and an acrylic resin is required to be used. Examples of such solvent include a hydrocarbon solvent such as aliphatic hydrocarbon, alicyclic hydrocarbon, and aromatic hydrocarbon, halogenated hydrocarbon such as halogenated methane, halogenated ethane, and halogenated benzene, and ether such as aliphatic ether and alicyclic ether. Examples of a desirable solvent include halogenated hydrocarbon such as methylene chloride, chloroform, carbon tetrachloride, bromoform, ethylene chloride, ethylidene chloride, trichloroethane, and tetrachloroethane, ether such as ethyl ether, isopropyl ether, ethyl butyl ether, butyl ether, 1,2-dioxyethane, dioxane, dimethyl dioxane, tetrahydrofuran, tetrahydropyran, cellosolve acetate, and carbitol acetate, and hydrocarbon such as pentane hexane, isohexane, methyl pentane, heptane, isoheptane, octane, isooctane, cyclopentane, methyl cyclopentane, cyclohexane, methyl cyclohexane, benzene, toluene, xylene, and ethyl benzene. In a case of using the solvent, two or more kinds of solvents may be mixed in order to adjust a dissolving degree of polysilazane and an evaporation speed of the solvent. An amount (ratio) of the solvent used can be appropriately adjusted by a coating method adopted so as to improve workability or according to the layer thickness required. Further, the solvent and a solid content in the coating liquid can be generally mixed within the range of 99 to 5 wt % and 1 to 95 wt %, respectively, although the mixture ratio varies depending on an average molecular weight, a molecular weight distribution, and a structure of polysilazane. The concentration of the solid content is desirably 5 to 60 wt %.

In this embodiment, perhydro-polysilazane is used as polysilazane, but polysilazane is not limited to this. Instead, for example, a polysilazane compound obtained by substituting a part of hydrogen atoms of a structural formula I as represented below with an alkyl group, an alkenyl group, a cycloalkyl group, an aryl group, a group other than those above and contains carbon directly linked with silicon, an alkylsilyl group, an alkylamino group, an alkoxy group, or the like can be used.

—(SiH₂NH)ₙ— I

(where, n represents an integer, desirably, about 100 to 50,000)

As an acrylic resin, various kinds of resins can be used. For example, the resin is made of a combination of acrylic acid ester (examples of an alcohol residue may include a methyl group, an ethyl group, an n-propyl group, an isopropyl group, an n-butyl group, an isobutyl group, a t-butyl group, a 2-ethylhexyl group, a cyclohexyl group, a phenyl group, a benzyl group, a phenylethyl group, and the like), methacrylate ester (examples of an alcohol residue are the same as above), a hydroxy-containing monomer such as 2-hydroxyethyl acrylate, 2-hydroxyethyl methacrylate, 2-hydroxypropyl acrylate, and 2-hydroxypropyl methacrylate, an amid group-containing monomer such as acrylamide, methacrylamide, N-methyl methacrylamide, N-methyl acrylamide, N-methylol acrylamide, N-methylol methacrylamide, N,N-dimethylol acrylamide, N-methoxymethyl acrylamide, N-methoxymethyl methacrylamide, and N-phenyl acrylamide, an amino group-containing monomer such as N,N-diethyl aminoethyl acrylate and N,N-diethylamino ethyl methacrylate, an epoxy group-containing monomer such as glycidyl acrylate, glycidyl methacrylate, and aryl glycidyl ether, a sulfonate group such as styrene sulfonic acid, vinyl sulfonic acid, and a salt thereof (e.g., sodium salt, potassium salt, and ammonium salt) or a monomer containing the salt, a carboxyl group such as crotonic acid, itaconic acid, acrylic acid, maleic acid, fumaric acid, and a salt thereof (e.g., sodium salt, potassium salt, and ammonium salt) or a monomer containing the salt, a monomer containing anhydride such as maleic anhydride and itaconic anhydride, another monomer such as vinyl isocyanate, aryl isocyanate, styrene, vinyl methyl ether, vinyl ethyl ether, vinyl tris alkoxysilane, alkyl maleic acid monoester, alkyl fumaric acid monoester, acrylonitrile, methacrylonitrile, alkyl itaconic acid monoester, vinylidene chloride, vinyl acetate, and vinyl chloride. Desirably, a (metha)acrylic monomer component such as an acrylic acid derivative and a methacrylic acid derivative is contained by 50 mol % or more. Particularly desirably, a methyl methacrylate component is contained.

In this embodiment, the acrylic resin is used as an organic resin, but the organic resin is not limited to this as long as compatibility with polysilazane, transparency, the water barrier property, and the like are satisfied. A copolymer including polyvinylidene chloride, polyvinylidene fluoride, and halo tri fluoro ethylene, a copolymer of vinylidene fluoride and tetrafluoroethylene, or the like can be used.

### Modified Example of Polarization Plate

Further, the polarization plate 1 of the above embodiment is provided with the protection layer 3 on both sides of the polarization film 2. However, as shown in FIG. 2, a polarization plate 101 in which the protection layer 3 is provided on only the first surface 2a of the polarization film 2 may be used. In a case where the polarization plate 101 is incorporated into the liquid crystal display apparatus, the polarization plate 101 only needs to be disposed so that the second surface 2b on which the protection layer 3 is not provided is disposed on a liquid crystal cell side. In the liquid crystal display apparatus, a pair of polarization plates is disposed so as to sandwich the liquid crystal cell. The liquid crystal cell has a structure in which two distanced glass substrates sandwich liquid crystal. The glass substrate has no water permeability. Therefore, water that intrudes from the liquid crystal cell side into the polarization plate is little, and water that intrudes thereinto mostly enters from a side opposite to the surface on which the liquid crystal cell of the polarization plate is disposed. Accordingly, in a state where the polarization plate is incorporated in the liquid crystal display apparatus, the protection layer is provided on the surface side opposite to the surface on the liquid crystal cell side of the polarization plate, with the result that water intrusion can be prevented. With this structure, even when the polarization plate 101 is incorporated into the liquid crystal display apparatus, the protection layer 3 can prevent water intrusion from outside. In addition, as compared to a case where the protection layer 3 is formed on both sides of the polarization film2, the production process can be simplified, which is effective in terms of a production cost.

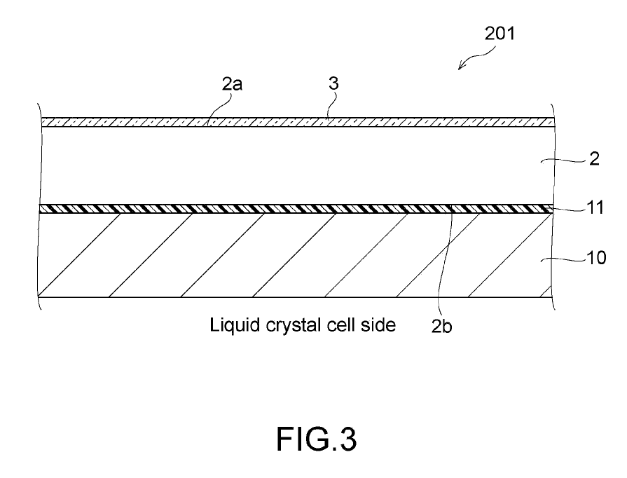

Further, the liquid crystal display apparatus is generally provided with, in addition to the polarization plate, an optical compensation film as an optical film for improving a view angle. Like an optical compensation film-attached polarization plate 201 shown in FIG. 3, an optical compensation film 10 may be provided on the second surface 2b of the polarization film 2 of the polarization plate 101 shown in FIG. 2 via an adhesive 11.

In this case, the optical compensation film-attached polarization plate 201 only needs to be incorporated into the liquid crystal display apparatus so that the second surface 2b of the polarization film 2 is disposed on the liquid crystal cell side.

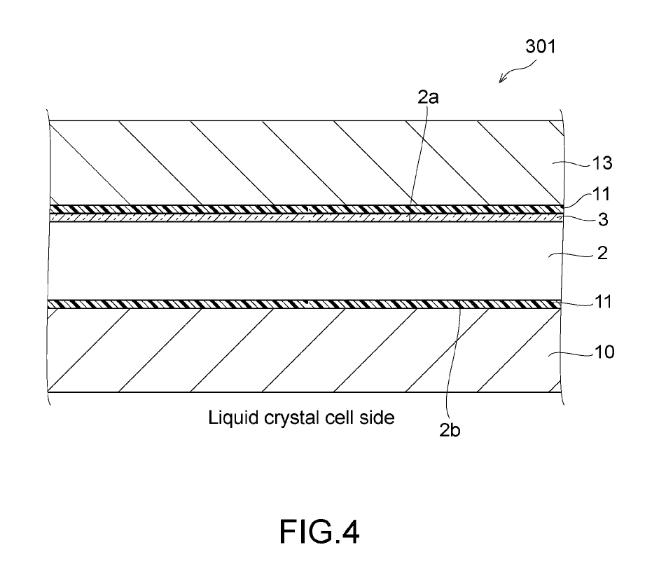

Further, like an optical compensation film-attached polarization plate 301 shown in FIG. 4, a protection film 13 may be provided on the protection layer 3 of the optical compensation film-attached polarization plate 201 shown in FIG. 3 via the adhesive 11. By thus providing the protection film 13, the surface can be prevented from being cracked.

It is to be noted that for the polarization plates shown in FIGS. 2 to 4, the same constituents as those shown in FIG. 1 are denoted by the same reference symbols, and the same constituents shown in FIGS. 2 to 4 are denoted by the same reference symbols.

(Liquid Crystal Display Apparatus)

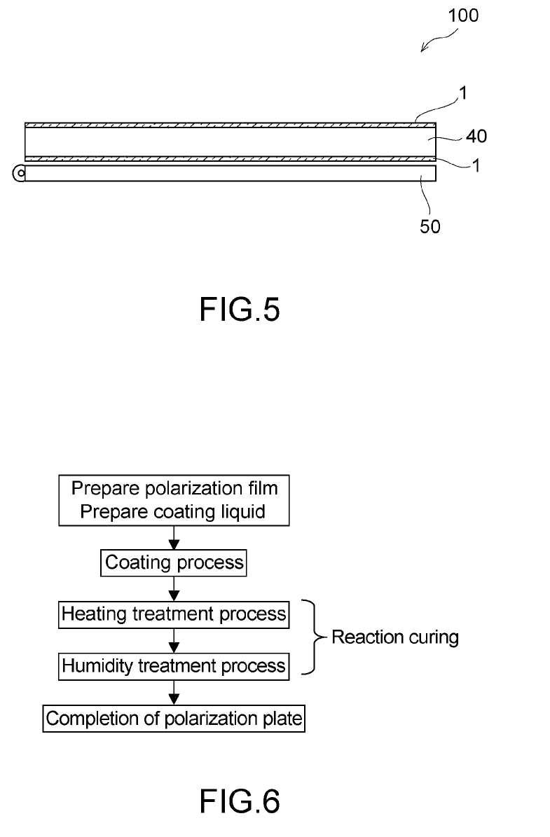

With reference to FIG. 5, a description will be given on a liquid crystal display apparatus as a display apparatus into which the polarization plate 1 manufactured by the above-mentioned manufacturing method is incorporated. Herein, a transmissive liquid crystal display apparatus will be explained as an example, but the liquid crystal display apparatus to which the present invention can be applied is not limited to this. The polarization plate manufactured by the manufacturing method of the present invention can also be used for a reflective liquid crystal display apparatus, a semi-transmissive liquid crystal display apparatus, and the like.

FIG. 5 is a schematic cross-sectional diagram showing a liquid crystal display apparatus 100.

As shown in FIG. 5, the liquid crystal display apparatus 100 includes a liquid crystal cell 40 as a display cell, a pair of polarization plates 1 disposed so as to sandwich the liquid crystal cell 40, and an illumination apparatus 50 disposed on one surface side of the liquid crystal cell 40. The liquid crystal cell 40 has a structure in which liquid crystal is sandwiched by two transparent substrates that are made of, e.g., glass and are apart from each other by a predetermined distance.

Further, as necessary, an optical compensation film (not shown) is provided between the liquid crystal cell 40 and the polarization plate 1 opposite to the one on the illumination apparatus 50 side.

In the liquid crystal display apparatus 100, the above-mentioned polarization plate 1 that is excellent in durability and has stable polarization characteristics is used, and therefore the liquid crystal display apparatus 100 having stable display characteristics can be obtained.

Further, instead of the above-mentioned polarization plate 1, any polarization plates shown in FIGS. 2 to 4 can be used.

It should be understood by those skilled in the art that various modifications, combinations, sub-combinations and alterations may occur depending on design requirements and other factors insofar as they are within the scope of the appended claims or the equivalents thereof.

TABLE 1

| | Mixture ratio (weight | Mixture ratio (weight | |
|---|---|---|---|
| | ratio) of | ratio) of polysilazane | |
| | polysilazane solution | component and acrylic | |
| | and acrylic resin | resin component in | |
| | solution in coating | coating liquid | |
| | liquid (polysilazane | (polysilazane | |
| Specimen | solution:acrylic | component:acrylic | Layer |
| name | resin solution) | resin component) | thickness |
| Example 1 | 3:4 | 3:2 | 1 μm |
| Example 2 | 1:2 | 1:1 | 1 μm |
| Example 3 | 1:3 | 2:3 | 1 μm |
| Example 4 | 1:8 | 1:4 | 1 μm |
| Example 5 | 1:18 | 1:9 | 1.1 μm |
| Comparative | No coating (no | — | — |
| example 1 | protection layer) | | |
| Comparative | Polysilazane solution | Polysilazane | 0.8 μm |
| example 2 | only | component only | |
| Comparative | 7:6 | 7:3 | 1 μm |
| example 3 | | | |
| Comparative | Acrylic resin | Acrylic resin | 1.2 μm |
| example 4 | solution only | component only | |
| Comparative | No coating (TAC was | — | 80 μm |
| example 5 | used as protection | | (TAC |
| | film) | | film) |

TABLE 2

| | Polarization | Polarization | Polarization plate | |
|---|---|---|---|---|
| Specimen | degree | degree after | condition | Pencil |
| name | before test | test | after test | hardness |
| Example 1 | 99.98% | 99.98% | No change | 4H |
| Example 2 | 99.98% | 99.98% | No change | 4H |
| Example 3 | 99.98% | 99.98% | No change | 4H |
| Example 4 | 99.98% | 99.98% | No change | 3H |
| Example 5 | 99.98% | 99.98% | No change | 3H |
| Comparative | 99.98% | 46% | Deformation and | 3H |
| example 1 | | | decolorization | |
| | | | due to | |
| | | | polarization film | |
| | | | swelling | |
| Comparative | 99.98% | 99.65% | Crack occurrence | 5H |
| example 2 | | | in layer, | |
| | | | Decolorization of | |
| | | | crack portion | |
| Comparative | 99.98% | 99.68% | Crack occurrence | 4H |
| example 3 | | | in layer | |
| Comparative | 99.98% | 99.82% | Deformation due | 2H |
| example 4 | | | to polarization | |
| | | | film swelling | |
| Comparative | 99.98% | 99.82% | Deformation due | — |
| example 5 | | | to polarization | |
| | | | film swelling | |

What is claimed is:

1. A manufacturing method of a polarization plate, comprising:
forming a coating layer on a polarization element by coating a coating liquid obtained by dissolving polysilazane and an organic resin into a solvent; and
forming an organic-inorganic hybrid layer by subjecting the coating layer to reaction curing.

2. The manufacturing method of a polarization plate according to claim 1,
wherein the organic resin is an acrylic resin.

3. The manufacturing method of a polarization plate according to claim 2,
wherein components of the polysilazane and the organic resin in the coating liquid are dissolved in the solvent at a weight ratio of 1:9 to 3:2.

4. The manufacturing method of a polarization plate according to claim 3,
wherein the polarization element has a base material film made of a polyvinyl alcohol resin.

5. The manufacturing method of a polarization plate according to claim 4,
wherein the reaction curing is performed through a heating treatment and a humidity treatment in the stated order.

6. The manufacturing method of a polarization plate according to claim 5,
wherein the humidity treatment is performed under a condition where a temperature is 40° C. or more and 80° C. or less and a humidity is 60% or more and 90% or less.

7. The manufacturing method of a polarization plate according to claim 6,
wherein the heating treatment is performed under a temperature condition of 60° C. or more and 100° C. or less.

8. A display apparatus, comprising:
a display cell; and
a pair of polarization plates each of which includes a polarization element including a first surface and a second surface opposed to each other and an organic-inorganic hybrid layer provided on the first surface and formed by coating a solution obtained by dissolving polysilazane and an organic resin into a solvent, and is disposed so that the second surface is disposed on a side of the display cell and the display cell is sandwiched thereby.
